(19) United States
(12) Patent Application Publication
(10) Pub. No.: US 2025/0347572 A1
(43) Pub. Date: Nov. 13, 2025

(54) A METHOD OF TRANSIENT TESTING A PRIME MOVER

(71) Applicant: Autoneura Ltd, Newport Pagnell Buckinghamshire (GB)

(72) Inventor: Alexander Bech, Newport Pagnell Buckinghamshire (GB)

(21) Appl. No.: 18/869,539

(22) PCT Filed: May 30, 2023
(86) PCT No.: PCT/GB2023/051424

§ 371 Date: Nov. 26, 2024

(30) Foreign Application Priority Data
May 30, 2022 (GB) 2207985.9

(51) Int. Cl. G01L 3/16; G05B 19/4155

(52) U.S. Cl. CPC G01L 3/16; G05B 19/4155; G05B 2219/34066

(57) ABSTRACT

A method of transient testing a prime mover wherein the prime mover is coupled to a power absorbing dynamometer. The method comprising the steps of: receiving a first load setpoint and a first rotational speed setpoint, wherein the first load setpoint and the first rotational speed setpoint correspond to a first time point in a prime mover testing profile, wherein the prime mover testing profile is a model of a real-world testing profile; outputting the first load setpoint or the first rotational speed setpoint to the power absorbing dynamometer; determining a first baseline prime mover demand input using a first feedforward loop; determining a first prime mover demand input, wherein the first prime mover demand input is based on the first baseline prime mover demand input and the first load setpoint or the first rotational speed setpoint; outputting the first prime mover demand input to the prime mover; wherein, upon the first load setpoint being provided to the power absorbing dynamometer, the first prime mover demand input is based on the first baseline prime mover demand input and the first rotational speed setpoint, and wherein, upon the first rotational speed setpoint being provided to the power absorbing dynamometer, the first prime mover demand input is based on the first baseline prime mover demand input and the first load setpoint; receiving a first load measurement value and a first rotational speed measurement value; and determining a second prime mover demand input based on: the first prime mover demand input or a second baseline prime mover demand input; a second load setpoint or a second rotational speed setpoint; and the first load measurement value or the first rotational speed measurement value.

### TECHNICAL FIELD

The present disclosure generally relates to a method and controller of transient testing a prime mover. In particular, the present disclosure relates to a method of transient testing a prime mover, where the prime mover is coupled to a power absorbing dynamometer.

### BACKGROUND

The process of transient testing a prime mover is known. Transient testing involves characteristics such as aggressive throttle movements and sudden prime mover rotational speed changes intended to model real-world driving conditions. It is important to be able to accurately and efficiently analyse and evaluate prime mover performance under these drive cycle conditions in order to improve powertrain development. However, the process can be lengthy and complicated requiring advanced equipment. This is turn results in a costly process. Further, for many of the known testing methods the repeatability of prime mover response is difficult to achieve for transient drive cycles.

For example, known testing methods require throttle position as an input parameter. Throttle position as an input parameter requires that the prime mover be mapped at over various operating conditions. If a full vehicle chassis dynamometer is available this in turn imposes a dependency on the facilities available. Further, if the throttle target is not achieved then the throttle input must be iteratively modified until such target throttle is achieved. This is a time-consuming process.

Power absorbing dynamometers are historically viewed in industry as suitable for running steady state tests with limited accuracy over transient events. Transient testing is commonly carried out with AC, DC or transient dynamometers. These dynamometers are expensive in comparison to a power absorbing dynamometer. The present inventor has appreciated it would be desirable to provide a method of transient testing a prime mover using a power absorbing dynamometer. Further, as mentioned above, known testing methods use a certain type of dynamometer for a certain type of test, such as steady state testing and transient testing type profiles. Using different dynamometers for particular tests can increase the time and costs of various processes, such as time spent commissioning rigs or setting up control systems for prime mover operation. The present inventor has appreciated it would be desirable to be able to utilise the same dynamometer for a variety of tests. Furthermore, electric motors are increasingly being used in vehicles, such as electric cars, boats and aircraft. To meet this increasing demand less expensive methods of transient testing, durability testing, NVH (noise, vibration, and harshness) testing, and failure tests must also be made available. This includes providing testing methods which are easily transferable between an electric motor and a combustion engine for example. The present inventor has appreciated it would be desirable to provide a method of transient testing a prime mover where the prime mover can be an electric motor.

### SUMMARY OF THE DISCLOSURE

Examples described herein provide a method of transient testing a prime mover. The present disclosure provides a method of transient testing a prime mover as defined in the appended independent claim, to which reference should now be made. Preferred or advantageous features of the disclosure are set out in the dependent sub-claims.

According to a first aspect of the present disclosure, there is provided a method of transient testing a prime mover wherein the prime mover is coupled to a power absorbing dynamometer. The method comprises the steps of, receiving a first load setpoint and a first rotational speed setpoint, where the first load setpoint and the first rotational speed setpoint correspond to a first time point in a prime mover testing profile. The prime mover testing profile is a model of a real-world testing profile or a transient profile. Outputting the first load setpoint or the first rotational speed setpoint to the power absorbing dynamometer. Determining a first baseline prime mover demand input using a first feedforward loop. Determining a first prime mover demand input, wherein the first prime mover demand input is based on the first baseline prime mover demand input and the first load setpoint or the first rotational speed setpoint. Outputting the first prime mover demand input to the prime mover, where, upon the first load setpoint being provided to the power absorbing dynamometer, the first prime mover demand input is based on the first baseline prime mover demand input and the first rotational speed setpoint, and wherein, upon the first rotational speed setpoint being provided to the power absorbing dynamometer, the first prime mover demand input is based on the first baseline prime mover demand input and the first load setpoint. Receiving a first load measurement value and a first rotational speed measurement value and determining a second prime mover demand input based on: the first prime mover demand input or a second baseline prime mover demand input; a second load setpoint or a second rotational speed setpoint; and the first load measurement value or the first rotational speed measurement value.

It will be appreciated that a prime mover defines a machine that converts one or more forms of energy into a mechanical force. For example, an internal combustion engine, an electric motor, or any prime mover with a rotational output. The prime mover demand input may be, however is not limited to, one of a throttle position input, a pedal position input, an electric motor throttle position, a throttle opening degree, and fuel injection of the prime mover. The prime mover demand input is dependent on three variables: the load profile, the rotational speed profile, and the time unit between each successive time point enabling receiving a load measurement value and a rotational speed measurement value from the prime mover.

Furthermore, it will be appreciated that the prime mover may be directly or indirectly coupled to the power absorbing dynamometer. The prime mover may be indirectly coupled to the power absorbing dynamometer via a gearbox.

The method according to the first aspect advantageously provides a method of transient testing, without motoring, a prime mover using a power absorbing dynamometer. The method is a closed loop method comprising both a feedforward loop and a feedback loop. The method according to the first aspect is able to operate and/or control a prime mover over transient or real-world operating profiles.

Power absorbing dynamometers are viewed in the state of the art as devices for steady state tests or modal type tests. However, the inventors have appreciated the benefits of using a power absorbing dynamometer for transient tests rather than for modal type tests. Steady state tests and modal type tests are where the prime mover is held at a specified RPM for a desired amount of time by adjusting the load input. Whereas with transient testing, the prime mover's power and rotational speed are varied throughout the testing profile. Transient testing can involve large prime mover demand inputs with steep rates of change for denominators of the prime mover's power profile. Power absorbing dynamometers are comparatively substantially cheaper than known dynamometers for transient testing, such as motored dynamometers or transient dynamometers. As such, by incorporating a power absorbing dynamometer into a transient testing method there may advantageously be a significant cost reduction in the development and testing process of prime movers.

Further, power absorbing dynamometers are capable of providing improved understanding of the efficacy of the prime mover at an earlier stage of the physical testing of a prime mover. As a result, using a power absorbing dynamometer more effectively improves the performance of the prime mover and consequently the powertrain.

The use of the present control method provides unexpectedly high accuracy control for a prime mover when testing with a power absorbing dynamometer. Such high accuracy control has previously only been considered possible using a transient, and therefore high cost, dynamometer. Particularly advantageously, is that the use of the present control method with a power absorbing dynamometer provides high accuracy testing for a wide range of prime movers. For example, the method according to the first aspect can be applied to both electric motors and internal combustion engines. Therefore, the method according to the first aspect is not limited to specific prime movers and more importantly the effectiveness of the method for transient testing according to the first aspect does not vary depending on the type of prime mover.

As mentioned, the method as defined by the first aspect advantageously allows precise control of the prime mover such that it can undergo transient or real-world operating profiles. The method according to the first aspect provides a means for accurately conducting simulation of a vehicle operating profile in the real world. The method according to the first aspect provides improved testing, in particular, the method provides improved precision when testing transient events. As such, the method allows for more effective transfer from testing prime movers to full testing of a powertrain compared to the prior art.

Further, the method is synchronised such that there is no lag between the feedback loop and the output which may cause instability. This is important because if the system is not synchronised there is high risk of error and lack of control accuracy.

The method according to the first aspect advantageously comprises both load and rotational speed inputs. The testing method according to the first aspect is capable of controlling both the load and the rotational speed in synchronisation and as such is able to monitor the transient events more effectively. Whereas, methods of transient testing a prime mover, such as known methods in the state of the art, that require switching between a load control mode and a rotational speed mode may lack reliability and accuracy.

It has also been appreciated that determining a first baseline prime mover demand input using a first feedforward loop advantageously stabilises the prime mover response during transient events. In particular, it prevents the prime mover from substantially under or overshooting the target rotational speed, for example, in response to large torque increments or decrements in the cycle. Further, providing a first feedforward loop configured to determine the first baseline prime mover demand input ensures that the prime mover always meet a minimum threshold prime mover demand input.

The method according to the first aspect is not limited to the order of the steps as recited. For example, the method may comprise the step of determining a first baseline prime mover demand input using a first feedforward loop before the step of outputting the first load setpoint or the first rotational speed setpoint to the power absorbing dynamometer. Further, there is also the option that the step of outputting the first load setpoint or the first rotational speed setpoint to the power absorbing dynamometer for example, may occur while the step of outputting the first prime mover demand input to the prime mover occurs. This is dependent on the frequency of the reading and new setpoint allocation to the prime mover.

It will be appreciated by the skilled person throughout the disclosure that the term ‘first’ represents the current or Nth point. Therefore, it will be understood that the term ‘second’ represents the next or (N+1)th point.

Optionally, the step of determining the second prime mover demand input further comprises performing an error calculation between one of: the first load measurement value and the second load setpoint; and the first rotational speed measurement value and the second rotational speed setpoint.

This step is configured to determine the next prime mover demand input based on the error calculation between the Nth load measurement value and the Nth+1 load setpoint or between the Nth rotational speed measurement value and the Nth+1 rotational speed setpoint. Performing an error calculation to determine the second prime mover demand input allows adjustments to be made to the prime move demand input based on the measurement values that have been fed back, i.e., information on the historic response in real-time at the prime mover. This advantageously provides improved and more accurate control of the prime mover.

Optionally, the error calculation comprises determining PID control terms. In particular, the error calculation comprises determining the proportional, integral and derivative terms of the PID controller. The PID controller is configured to continuously perform an error calculation, i.e., the difference between a desired load setpoint and the load measurement value or the difference between a desired rotational speed setpoint and the rotational speed measurement value. This advantageously provides a means of determining PID control terms. This is important as the PID control terms are configured to correct and/or adjust the prime mover demand input based on error calculation. Advantageously, using PID control combines the benefits of each type of control (proportional, integral and derivative control) and as a result provides stability to the system. Further, using PID control terms is beneficial as they may not require modification to coefficients when transferring the control system to different prime mover sizes, or types.

Alternatively, the error calculation may comprise determining PI control terms only. PI control lacks the derivative control of the PID system.

Optionally, the PID control terms are determined using a fuzzy logic gain scheduling system. Advantageously, using a fuzzy logic gain scheduling system improves the PID control performance. Fuzzy logic allows the system to make decisions based on ranges of data as opposed to one discrete point. The fuzzy logic gain scheduling system may be configured to adjust the gain coefficients of the PID control terms such that the error between the inputted setpoints and the measurement value fed back reaches zero as quickly and effectively as possible.

Optionally, the fuzzy logic gain scheduling system is configured to: determine a fuzzy input variable, wherein the fuzzy input variable is based on, an error value and a change in error value, wherein the error value is the difference between one of: the first load measurement value and the first load setpoint; and first rotational speed measurement value and the first rotational speed setpoint; receive fuzzy set data; determine a fuzzy output variable based on the fuzzy input variable and the fuzzy set data; and adjust the PID control terms based on the fuzzy output variable.

Fuzzy logic gain scheduling provides fuzzy logic to determine the PID gain coefficients based on the error value and the rate of change of the error value. The received fuzzy set data may comprise a plurality of overlapping fuzzy sets. Overlapping fuzzy sets advantageously provide a smooth and continuous control signal. The fuzzy logic gain scheduling system may be configured to map the fuzzy input variables into predetermined fuzzy sets. The step of adjusting the PID control terms based on the fuzzy output variable advantageously provides precise control for the specific type of operating characteristic, for example, high acceleration events.

Optionally, the fuzzy logic gain scheduling system further comprises determining a degree of membership of the fuzzy input variable associated with the fuzzy set, wherein determining the fuzzy output variable is further dependent on the degree of membership. Fuzzy sets have degree of membership or in other words a membership function. This degree of membership quantifies the degree to which the fuzzy input variable is an element of said fuzzy set. For example, the value 0 means that the fuzzy input variable is not a member of that fuzzy set, the value 1 means that the fuzzy input variable is a member of that fuzzy set and the values between 0 to 1 mean that the fuzzy input variable is only partially a member of that fuzzy set. The use of the fuzzy logic gain scheduling system comprising determining a degree of membership provides a wider range of outputs. It is not limited purely to definite results such as 0 or 1 and true or false as per Boolean Logic. Advantageously, this provides a specific fuzzy output variable that can satisfy precise control for that specific type of operating characteristic, i.e., specific rates of change or types of rotational speed or load.

Optionally, the fuzzy input variable is further based on the rate of change between the first load measurement value and the second load measurement value and/or between the first rotational speed measurement value and the second rotational speed measurement value.

Optionally, the fuzzy logic gain scheduling system further comprises a neural network such that the PID control terms are determined using a neuro-fuzzy gain scheduling system. The addition of the neural network advantageously uses a learning algorithm to determine the parameters of the fuzzy logic gain scheduling system such as the fuzzy sets. In other words, it provides a form of machine learning by exploiting approximation techniques from neural networks. Advantageously, the neural network is configured to re-evaluate the appropriate PID gain coefficients and as such allows the neuro-fuzzy gain scheduling system to provide more precise PID control terms and as a result more precise control of the prime mover.

Optionally, the PID integral term is reset upon the second rotational speed setpoint being equal to an idling rotational speed of the prime mover. The system is configured to recognise when the first baseline prime mover demand input is that required for idling conditions, i.e., when the second rotational speed setpoint is equal to an idling rotation speed of the prime mover. As such, when receiving a first baseline prime mover demand input equivalent to an idling prime mover demand input the error calculation channeled to the integral action is nullified and thus the integral action at the beginning of idling periods remains constant to the value previously outputted. This advantageously reduces large errors and the eventuality of large accumulation of integral action during idling periods.

Preferably, the integral term is reset upon being greater than an upper threshold value, or upon being less than a lower threshold value. This means that whenever the prime mover is idling the integral term is reset once it has reached a threshold. In other words, the system comprises an integral windup nullifier which is configured to nullify the integral term of the PID control term used to determine the prime mover demand input. This advantageously prevents instability within the system.

Alternatively, the integral term may be reset upon being the same or greater than an upper threshold value, or upon being the same or less than a lower threshold value.

Optionally, the upper threshold value is between about 7,500 and about 12,500 and the lower threshold value being between about −7,500 and about −12,500. Preferably, the upper threshold value is between about 9,000 and about 11,000 and the lower threshold value being between about −9,000 and about −11,000. More preferably, the upper threshold value is about 10,000 and the lower threshold is about −10,000.

Optionally, the step of determining a first baseline prime mover demand input using a first feedforward loop comprises comparing the first load setpoint to a second load setpoint and/or the first rotational speed setpoint to a second rotational speed setpoint.

The first feedforward loop is configured to provide a baseline prime mover demand input based on the next input. The control system is then configured to alter and adjust this baseline prime mover demand input based on the error calculation, in order to output an appropriate prime mover demand input. The PID control terms are configured to work off the first baseline prime mover demand input. The first feedforward loop is advantageously minimising the work that the PID controller has to undergo.

Optionally, the step of determining a first baseline prime mover demand input using a first feedforward loop further comprises comparing the difference between the first load setpoint and the second load setpoint to a first feedforward load threshold value and/or comparing the difference between the first rotational speed setpoint and the second rotational speed setpoint to a first feedforward rotational speed threshold value.

The first feedforward loop may comprise a threshold. When said threshold is exceeded the first feedforward loop is triggered and in turn determines a first baseline prime mover demand input. The first feedforward loop is configured to compare the difference between a setpoint one time step ahead and the current setpoint to a pre-determined threshold value. Thus, the first feedforward loop is not activated upon the difference between the current and subsequent time step setpoints being less than the threshold.

Optionally, the first feedforward threshold value is between about 0 Nm to about 50 Nm. Preferably, the first feedforward threshold value is between about 0 Nm to about 25 Nm. More preferably, the first feedforward load threshold value is between about 0 Nm to about 10 Nm. In one particular embodiment, the first feedforward load threshold value is about 10 Nm.

Optionally, the first feedforward rotational speed threshold value is between about 0 RPM to about 50 RPM. Preferably, the first feedforward threshold value is between about 0 RPM to about 25 RPM. More preferably, the first feedforward rotational speed threshold value is between about 0 Nm to about 10 Nm. In one particular embodiment, the first feedforward rotational speed threshold value is about 10 RPM.

The first feedforward threshold values are generally kept quite low such that the first feedforward loop almost always acts.

Optionally, the method includes, upon the first load setpoint being equal to the second load setpoint, setting the first baseline prime mover demand input to the first prime mover demand input, and/or upon the first rotational speed setpoint being equal to the second rotational speed point setting the first baseline prime mover demand input to the first prime mover demand input.

Optionally, the method includes, upon the first load setpoint being greater than or less than the second load setpoint, setting the first baseline prime mover demand input in dependence on the second load setpoint, and/or upon the first rotational speed setpoint being greater than or less than the second rotational speed point setting the first baseline prime mover demand input in dependence on the second rotational speed setpoint.

Providing a first baseline prime mover demand input advantageously stabilises the prime mover response during transient events. In particular, it prevents the prime mover from substantially under or overshooting the target rotational speed, for example, in response to large torque increments or decrements in the cycle. Further, providing a first feedforward loop configured to determine the first baseline prime move demand input ensures that the prime mover always meet a minimum threshold prime mover demand input. It also allows for minimal prime move demand input adjustments with respect to the specific operating conditions and measurement values which in turn minimises the magnitude of change in the prime mover demand input outputted through the closed loop control system.

Optionally, upon the first rotational speed setpoint being equal to the idling rotational speed setpoint of the prime mover, the step of determining a first baseline prime mover demand input further comprises using a second feedforward loop.

The idling rotational speed setpoint of the prime mover may be a pre-determined setpoint. The idling rotational speed setpoint will be dependent on the type of prime mover. For example, an electric motor will have an idling rotational speed setpoint of 0 RPM. The first rotational speed setpoint refers to the current rotational speed setpoint being equal to the idling rotational speed setpoint of the prime mover.

The second feedforward loop is triggered upon the first rotational speed setpoint being equal to the idling rotational speed setpoint of the prime mover. In other words, N_{current}=N_{idling}.

Alternatively, wherein the step of determining a first baseline prime mover demand input further comprises using a second feedforward loop triggered during rotational speed setpoint not being equal to the idling rotational speed of the prime mover.

The second feedforward loop may be triggered upon a substantially constant rotational speed being greater than the idling rotational speed of the prime mover.

Optionally, the second feedforward loop is triggered upon the first rotational speed or load setpoint being greater or less than said threshold value for the Nth setpoint. In other words, N_{current}≤Nₙ, N_{current}≥Nₙ, T_{current}≤Tₙ, Or T_{current}≥Tₙ.

The second feedforward loop may be triggered upon a substantially constant rate of change of rotational speed or load. Further, the second feedforward loop may be triggered upon the rate of change of the rotational speed or load being greater or less than a pre-determined threshold value for rate of change of rotational speed or load.

Optionally, said second feedforward loop comprises comparing a difference between the first load setpoint and an Nth load setpoint to a second feedforward load threshold value and/or comparing a difference between the first rotational speed setpoint and an Nth rotational speed setpoint to a second feedforward rotational speed threshold value.

The second feedforward loop is configured to look a predetermined number of time points ahead. The value of the Nth term may be dependent on the frequency at which the error calculation is carried out. The second feedforward loop advantageously provides a first baseline prime mover demand input during idling and/or high transient events. This step is configured such that if the difference between, for example, the first rotational speed setpoint and an Nth rotational speed setpoint is greater than the predetermined threshold the second feedforward will retain its previously outputted baseline prime mover demand input. This advantageously ensures a minimum prime mover demand input is satisfied so that the testing systems response is rapid and any adjustments in the actual speed requires minimal effort from the PID system.

Further, the second feedforward loop ensures the prime mover does not stall or that parts of the system are not damaged or do not break under the high transient events. The second feedforward loop advantageously allows the system to provide a baseline prime mover demand input at least one time point in advance compared to what is required when the threshold is exceeded. As such, the prime mover and system as a whole can effectively manage the strenuous amount of load or rotational speed increase required according to the upcoming setpoints.

Optionally, the second feedforward load threshold value is between 0 Nm to 100 Nm. Preferably, the second feedforward load threshold value is between 0 Nm to 50 Nm. More preferably, the second feedforward load threshold value is between about 0 Nm to 25 Nm. In one particular embodiment, the second feedforward load threshold is about 25 Nm.

Optionally, the second feedforward rotational speed threshold value is between 0 RPM to 100 RPM. Preferably, the second feedforward rotational speed threshold value is between 0 RPM to 50 RPM. More preferably, the second feedforward rotational speed threshold value is about 25 RPM.

Optionally, the first feedforward load threshold value is the same or less than the second feedforward load threshold value and wherein the first feedforward rotational speed threshold value is the same or less than the second feedforward rotational speed threshold value.

The second feedforward threshold values are the same or greater than the first feedforward thresholds values. This is advantageous because the second feedforward loop is configured to handle large changes in rotational speed and load of the prime mover compared to what the first feedforward loop is configured to handle. Therefore, the control system is set up such that the second feedforward threshold value will most likely be greater than the first feedforward threshold value as the second feedforward loop is configured to look for more aggressive transient events.

The first baseline prime mover demand input is determined by the second feed forward loop upon the first rotational speed point being equal to the idling rotational speed setpoint of the prime mover and the difference between the first load setpoint and an Nth load setpoint exceeding the second feedforward load threshold, and/or upon the difference between the first rotational speed setpoint and an Nth rotational speed setpoint exceeding the second feedforward rotational speed threshold value and wherein the first baseline prime mover demand input is determined by the first feed forward loop upon the difference between the first load setpoint and the second load setpoint being greater than the first feedforward load threshold, and/or upon the difference between the first rotational speed setpoint and the second rotational speed setpoint being greater than the first feedforward rotational speed threshold value.

This method step is preferably configured such that the second feedforward loop overrides the first feedforward loop upon first rotational speed point being equal to the idling rotational speed setpoint of the prime mover.

The first feedforward loop and the second feedforward loop preferably run simultaneously. The first feedforward loop is configured to provide a baseline prime mover demand input based on the next input, while the second feedforward loop is looking two inputs ahead of time. Both the first and second feedforward loop advantageously allow the controller and the prime mover to manage and prepare for high transient events. As such, this provides a more durable testing system with reduced error.

Preferably, the Nth load setpoint is the third load setpoint and/or wherein the Nth rotational speed setpoint is the third rotational speed setpoint.

The Nth value is dependent on the frequency of the error calculation. The Nth setpoint may be further ahead than the third setpoint upon the frequency of the error calculation being decreased. However, if the Nth value is too great errors in the control system and oscillations may occur. As such, the Nth value is determined such that the control system functions effectively.

Optionally, both, or at least one the first feedforward and the second feedforward load threshold values and/or both the first feedforward and the second feedforward rotational speed threshold values are determined in dependence on the inertia of the prime mover. For example, for a prime mover with a higher inertia the load threshold value may be greater than that for a prime mover with a lower inertia.

Further optionally, both, or at least one of the first feedforward and the second feedforward load threshold values may be at least the reciprocal of a rated load of the prime mover. In this case, preferably, the load threshold value is greater than the reciprocal of a rated load of the prime mover.

Optionally, the step of determining the prime mover demand input is carried out at a frequency dependent on the maximum rotational speed of the prime mover.

As such, it may be seen that the error calculation is carried out at a frequency dependent on the maximum rotational speed of the prime mover. For example, if said prime mover is a high rotational device such as an electric motor, that operates at a frequency two to three times greater than that of an internal combustion engine, the frequency of determining the prime mover demand input may increase in order to achieve high accuracy at these high rotational speeds.

The frequency may also be dependent on the frequency at which the prime mover is able to react to feedforward or feedback signals. Further, the frequency may also be dependent on the frequency at which the information is provided to the prime mover and relayed back to the control system. The frequency may be further affected by the accuracy of the fuel injection and/or the inertia of the system. This step is important because if the step of determining the prime mover demand input is carried out at a frequency too high this could result in an over responsive control system which may in turn produce an undesirable level of oscillations. As such, ensuring this step is carried out at the appropriate frequency provides improved performance of the testing method and maintains a minimal number of oscillations.

Preferably, the frequency is between 1/50th and 1/5000th of the rotational speed of the prime mover. More preferably, the frequency is between 1/100th and 1/1000th of the rotational speed of the prime mover.

Alternatively, the frequency is between about 1 Hz and about 100 Hz. Preferably, the frequency is between about 5 Hz and 30 Hz. More preferably, the frequency is about 10 Hz. As mentioned above, this frequency is dependent on the prime mover.

The time between a first time point and a second time point in the prime mover testing profile may be between about 0.1 seconds and about 2 seconds, preferably about 1 second.

Optionally, for each step of determining the prime mover demand input between a first time point and a second time point of the prime mover testing profile, the load setpoint and the rotational setpoint remain constant. In other words, for one time point the load setpoint and the rotational setpoint may remain constant. The load setpoint and the rotational speed setpoint may change per time point. However, if the load setpoint and the rotational speed setpoint are outputted numerous times during said one time point the value of the load setpoint and the rotational speed setpoint will remain constant according to this method step.

Optionally, the step of determining a first prime mover demand input includes using a look-up table, based on the load setpoint and the rotational speed setpoint. This step involves using a look-up table which translates the load setpoint and/or rotational speed setpoint to a first prime mover demand input, for example, to a pedal position that corresponds to that load setpoint according to the look-up table for that specific prime mover.

Optionally, the load measurement value and the rotational speed measurement value are received from the power absorbing dynamometer. The power absorbing dynamometer may comprise a sensor. In particular, the power absorbing dynamometer may comprise a torque transducer or a load cell transducer. The torque transducer or the load cell transducer may provide an electrical signal that is proportional to the torque and as such provide an accurate load measurement value. The rotational speed measurement value may be received from a speed sensor. Additionally, standard power absorbing dynamometers generally consist of an absorption unit and a means for measuring load and rotational speed. As such, the pre-manufactured means for measurement load and rotational speed may be used to provide the load measurement value and the rotational speed measurement value. These measurement means advantageously provide feedback to the system and more specifically provides high accuracy feedback to the system.

Alternatively, the load measurement value and the rotational speed measurement value may be received from at least one sensor mounted to the output shaft of the prime mover. The said at least one sensor may be a torque transducer configured to measure torque directly from the shaft. The said at least one sensor may be a speed sensor and/or an infrared sensor configured to measure the rotational speed. The sensor may be configured to count the number of rotations per minute and feed this back to the control system. This advantageously provides feedback to the system and more specifically provides high accuracy feedback to the system.

Further optionally, the load measurement value and rotational speed measurement value may be received from the prime mover. The prime mover may be configured to determine the load measurement based on a fuel consumption map which associates fuel consumption with a load measurement. The rotational speed measurement value may be obtained from the rotational speed of the prime mover, which could be measured using an appropriate sensor such as a speed sensor. Other suitable sensors and measurement techniques will be appreciated by the person skilled in the art.

Optionally, the frequency at which the load measurement value and the rotational speed measurement value are received is substantially equal to the frequency of carrying out the step of determining the prime mover demand input. This further assists in ensuring the testing method is synchronised.

Optionally, the prime mover is an electric motor. In particular, the prime mover is an electric motor with an electric drive unit comprising of an inverter and controlled by a prime mover demand input. The prime mover demand input for the electric motor may be specifically a corresponding signal for a throttle position. The method advantageously provides a high accuracy transient testing method for an electric motor.

Alternatively, the prime mover is a combustion engine. Other prime movers will be appreciated by the skilled person. The power absorbing dynamometer used in the testing method according to the first aspect provides a high accuracy control system for both electric motors and combustions engines.

According to a second aspect of the present disclosure, there is provided a controller for a testing apparatus for transient testing a prime mover, the controller is configured to carry out the method as described herein. This is advantageous as it provides a controller configured to carry out transient testing which may be compatible with any prime mover and power absorbing dynamometer.

Any feature in one aspect of the disclosure may be applied to other aspects of the disclosure, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the disclosure can be implemented and/or supplied and/or used independently.

### BRIEF DESCRIPTION OF THE DRAWINGS

Embodiments of the disclosure will now be further described by way of example only and with reference to the accompanying figures in which:

FIG. 1 shows a schematic diagram of the transient testing method for a prime mover;

FIG. 2 shows a flow diagram of a method embodying the present disclosure;

FIG. 3 shows a flow diagram of a further method embodying the present disclosure;

FIG. 4 shows a flow diagram of a further method using a fuzzy logic gain scheduling system embodying the present disclosure;

FIG. 5 shows a flow diagram of a further method embodying the present disclosure;

FIG. 6 shows a flow diagram of a further method embodying the present disclosure;

FIG. 7 shows a flow diagram of a further method embodying the present disclosure;

FIG. 8 shows a flow diagram of a further method embodying the present disclosure;

FIG. 9 shows a flow diagram of a further method embodying the present disclosure;

FIG. 10 shows a schematic diagram of a control logic method embodying the present disclosure; and

FIG. 11 shows a sequence diagram of a further method embodying the present disclosure.

FIG. 12 shows a further schematic diagram of a control system embodying the present disclosure.

FIG. 13 shows a schematic diagram of a data interaction map; and

FIG. 14 shows a further schematic diagram of a data interaction map.

Like reference numbers are used for like elements throughout the description and figures.

### DETAILED DESCRIPTION

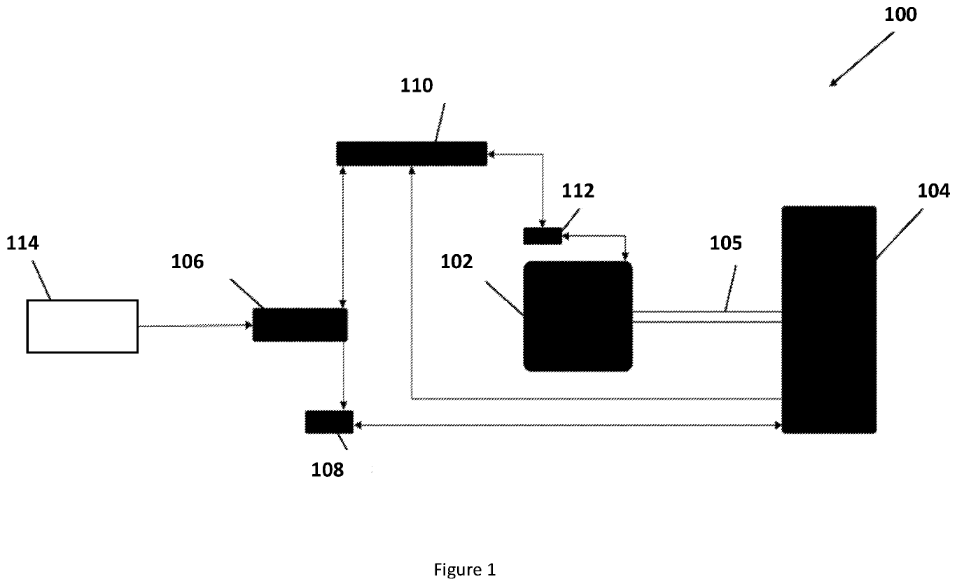

FIG. 1 illustrates the control system 100 of the method of transient testing a prime mover according to the first aspect. The control system 100 comprises a prime mover 102 coupled to a power absorbing dynamometer 104. The power absorbing dynamometer 104 is coupled to the output shaft 105 of the prime mover 102. The prime mover 102 may be any machine that converts one or more forms of energy into mechanical force. For example, an internal combustion energy or an electric motor.

The control system 100 further comprises a controller 106. The controller 106 is broadly configured to receive and provide data and/or control signals. The controller 106 of the example embodiment comprises a PID controller. The controller 106 receives a first load setpoint and a first rotational speed setpoint. The first load setpoint and the first rotational speed setpoint correspond to a first time point in a prime mover testing profile 114. The prime mover testing profile is a model of a real-world testing profile.

In the example embodiment of FIG. 1, the controller 106 outputs the first load setpoint to the power absorbing dynamometer 104. In particular, the first load setpoint is outputted to power absorbing dynamometer control unit 108 where it is then outputted as a first load setpoint control signal to the power absorbing dynamometer 104. The controller receives 106 a first baseline prime mover demand input. The first baseline prime mover demand input is determined and outputted using a first feedforward loop, not shown in this Figure.

The controller 106 determines a first prime mover demand input. In this example embodiment, the first prime mover demand input is based on the first baseline prime mover demand input received from the first feedforward loop, and the first rotational speed setpoint. This first prime mover demand input is then outputted to the prime mover 012.

The controller 106 receives a first load measurement value and a first rotational speed measurement value from the power absorbing dynamometer 104. These measurement values can be received from one of, the power absorbing dynamometer 104, the shaft 105 coupling the prime mover and the absorbing dynamometer, or the prime mover 102 itself. In this example embodiment, the first load measurement value and a first rotational speed measurement value are received from the power absorbing dynamometer 104.

The controller 106 is also configured to determine a second prime mover demand input based on: the first prime mover demand input or a second baseline prime mover demand input; a second rotational speed setpoint; and the first rotational speed measurement value in this example embodiment.

As can been seen in FIG. 1, the control system 100 may further comprise a signal acquisition and emulation system 110. The signal acquisition and emulation system 110 is configured to emulate the prime mover demand input into a readable signal for the prime mover 102, or in this example embodiment for a control unit of the prime mover 112.

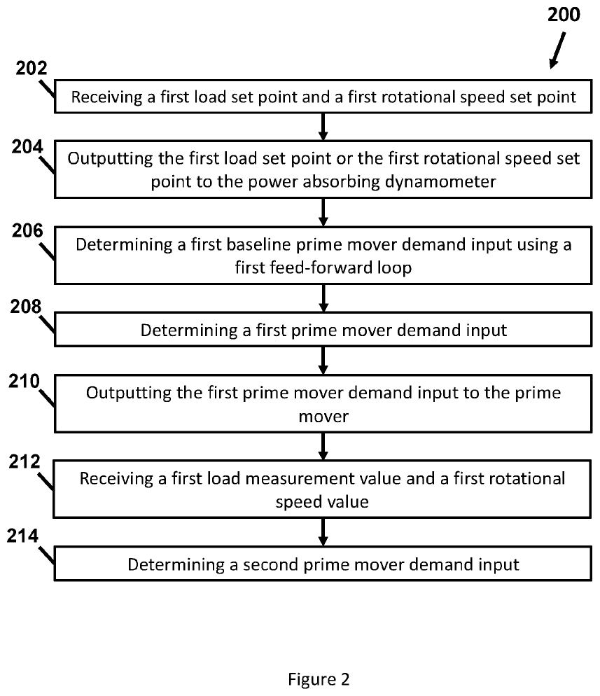

The method of transient testing a prime mover wherein the prime mover is coupled to a power absorbing dynamometer using the control system described above will be described below with reference to FIGS. 2 to 9.

FIG. 2 illustrates an example method of transient testing a prime mover embodying the present disclosure. The method 200 comprises a step 202 of receiving a first load setpoint and a first rotational speed setpoint. The first load setpoint and the first rotational speed setpoint correspond to a first time point in prime mover testing profile, where the prime mover testing profile is a model of a real-world testing profile. In this example embodiment as represented by FIG. 2, the time between a first time point and a second time point in the prime mover testing profile is about 1 second.

The method 200 further comprises a step 204 of outputting the first load setpoint or the first rotational speed setpoint to the power absorbing dynamometer 104. The setpoint outputted is dependent on the prime mover control. For example, FIG. 1 illustrates rotational speed prime mover control. Therefore, it is the first load setpoint that is outputted to the power absorbing dynamometer 104.

Step 206 is determining a first baseline prime mover demand input using a first feedforward loop. The first feedforward loop provides the first baseline prime mover demand input to the control system. The first feedforward loop is configured to look one time step ahead. This step is provided to stabilise the prime mover response during transient events. In particular, it prevents the prime mover from substantially under or overshooting the target rotational speed for example in response to large torque increments or decrements in the cycle. Further, providing a first feedforward loop configured to determine the first baseline prime move demand input ensures that the prime mover always meet a minimum threshold prime mover demand input.

The method 200 further comprises a step 208 of determining a first prime mover demand input and a step 210 of outputting the first prime mover demand input to the prime mover 102. The first prime mover demand input is based on the first baseline prime mover demand input and the first load setpoint or the first rotational speed setpoint. Upon the first load setpoint being provided to the power absorbing dynamometer 104, the first prime mover demand input is based on the first baseline prime mover demand input and the first rotational speed setpoint. Whereas, upon the first rotational speed setpoint being provided to the power absorbing dynamometer 104, the first prime mover demand input is based on the first baseline prime mover demand input and the first load setpoint. The first prime mover demand input may be a throttle position input for example for a combustion engine.

Step 210 of outputting the first prime mover demand input to the prime mover 102 may involve a further step of outputting the first prime mover demand input to a signal acquisition and emulation system 110. The emulation system 110 is configured to precisely emulate the prime mover demand input as a readable signal to the prime mover 102. The system proportionally assigns a signal to said prime mover demand input based on a prime mover demand input map. The control signal to said prime mover 102 may use a CAN bus communication protocol or any other communication protocol known to the person skilled in the art.

The method 200 comprises a step 212 of receiving a first load measurement value and a first rotational speed measurement value. This step provides the required information to determine whether the measured value, i.e., what is actually happening is the equivalent to the setpoint, i.e., the target and/or desired value.

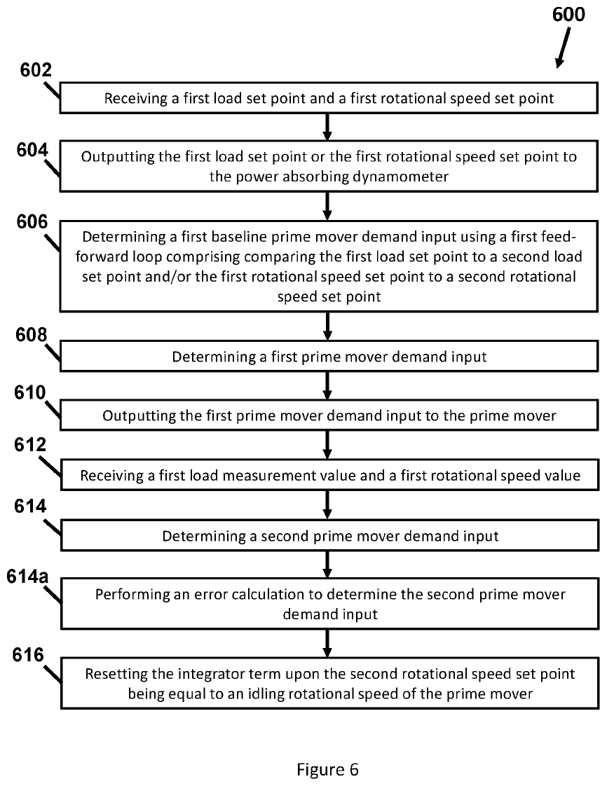

Further, the method 200 comprises a step 214 of determining a second prime mover demand input based on: the first prime mover demand input or a second baseline prime mover demand input; a second load setpoint or a second rotational speed setpoint; and the first load measurement value or the first rotational speed measurement value. The second prime mover demand input will be based on at least the second load setpoint and the first load measurement upon the first prime mover demand input being based on the first load setpoint. The second prime mover demand input will be based on at least the second rotational speed setpoint and the first rotational speed measurement upon the first prime mover demand input being based on the first rotational setpoint. Whether the second prime mover demand input is based on at least the first prime mover demand input, or a second baseline prime mover demand input will be discussed in more detail with regards to FIG. 6 and the first feedforward loop.

Step 208 of determining the first prime mover demand input and/or step 214 of determining the second prime mover demand input may be carried out at a frequency dependent on the maximum rotational speed of the prime mover 102. As such, the frequency will be dependent on the prime mover 102. In this example embodiment, the frequency at which step 208 and/or step 214 are carried out is about 10 Hz.

It will be appreciated that the method steps are not limited to the order represented and recited in FIG. 2 and throughout the Figures. For example, step 206 may occur before step 204.

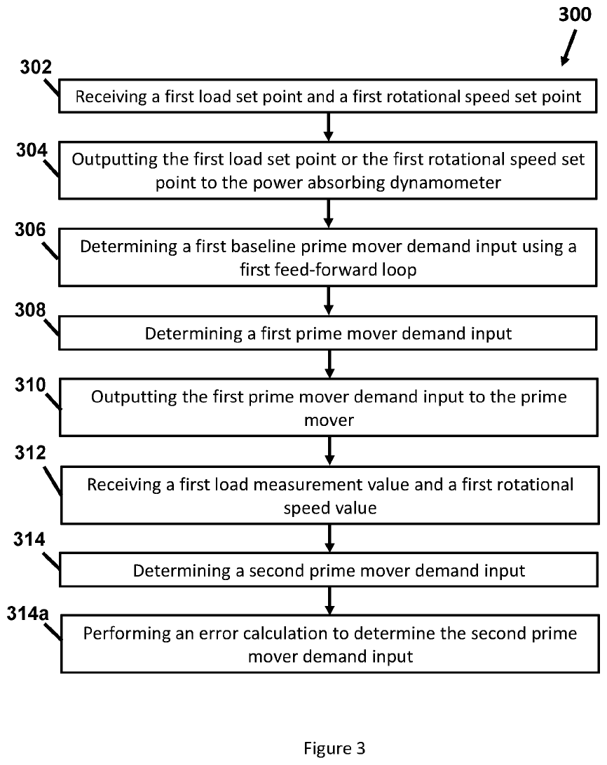

FIG. 3 illustrates a further example method 300 of transient testing a prime mover 102 embodying the present disclosure. Some of the steps of method 300 are identical to method 200, in particular steps 302, 304, 306, 308, 310, 312 and 314 which are identical to steps 202, 204, 206, 208, 210, 212 and 214. The method 300 further comprises a step 314a of performing an error calculation to determine the second prime mover demand input. In particular, performing an error calculation between one of: the first load measurement value and the second load setpoint; and the first rotational speed measurement value and the second rotational speed setpoint. The error calculation is performed between the first load measurement value and the second load setpoint when the prime mover 102 is being controlled based on load and the power absorbing dynamometer 104 is being controlled based on rotational speed. In other words, when the first prime mover demand input is determined based on the first load setpoint the error calculation will be between the first load measurement value and the second load setpoint. Whereas, when the first prime mover demand input is determined based on the first rotational speed setpoint the error calculation is between the first rotational speed measurement value and the second rotational speed setpoint. The purpose of the error calculation is to adjust the prime mover demand input based on the target value, i.e., the setpoint, and what has historically occurred in real-time based on the feedback from the measurement values, in order to obtain measurement values which are substantially the same as the setpoints. Therefore, the aim of the adjusting and correcting the prime mover demand input is to try and produce an error value of zero.

Further, said error calculation in step 314a may occur a plurality of times depending on the frequency of the feedback loop before the step 314 occurs of determining a second prime mover demand input occurs. The second prime mover demand input it then outputted to the prime mover, i.e., step 310 repeats.

Step 314a may further comprise determining PID control terms. As such the method 300 may use a PID controller 106. Other control systems will be known to the person skilled in the art. This step is configured to correct the error between the measured variable and the desired setpoint by calculating the difference and then performing a corrective action to adjust the second prime mover demand input accordingly. Step 314a may specifically determine the proportional, integral, and derivative control terms. These control terms can be weighted and/or adjusted using a fuzzy logic gain scheduling system.

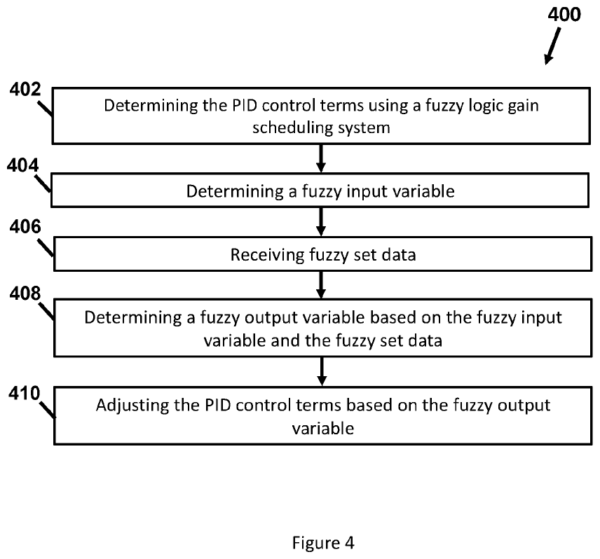

FIG. 4 illustrates a further example method 400 of a fuzzy logic gain scheduling system used determine the PID controls terms used to transient test a prime mover 102 embodying the present disclosure. In particular, the example method 400 illustrates the sub-steps that may be involved in method step 314a.

The method 400 comprises a step 402 of determining the PID control terms using a fuzzy logic gain scheduling system. Fuzzy logic allows the system to make decisions based on ranges of data as opposed to one discrete point. The fuzzy logic gain scheduling system may be configured to adjust the gain coefficients of the PID control terms such that the error between the setpoints and the measurement value reaches zero as efficiently and effectively as possible.

The method 400 further comprises a step 404 of determining a fuzzy input variable. The fuzzy input variable is based on an error value, a change in error value and/or the rate of change in the rotational speed and/or load. The error value is the difference between one of: the first load measurement value and the first load setpoint; and the first rotational speed measurement value and the first rotational speed setpoint. The change in error value is the difference between a second error value and a first error value, where the second error value is the difference between one of: a second load measurement value and the second load setpoint; and a second rotational speed measurement value and a second rotational speed setpoint. In other words, the error value is the difference in what the system inputted into the prime mover 102, i.e., the target value and what was outputted by the prime mover 102, i.e., the actual value. Further, when the first prime mover demand input is determined based on the first load setpoint, the first error value will be between the first load measurement value and the first load setpoint. Whereas, when the first prime mover demand input is determined based on the first rotational speed setpoint the first error value is between the first rotational speed measurement value and the first rotational speed setpoint.

The method 400 further comprises a step 406 of receiving fuzzy set data. The received fuzzy set data may comprise a plurality of predetermined overlapping fuzzy sets. Fuzzy sets are sets that allow its members to have a different degree of membership. The next step of the method 400 is step 408 of determining a fuzzy output variable based on the fuzzy input variable and the fuzzy set data. In particular, the fuzzy logic gain scheduling system may output a fuzzy output variable for each of the proportional, integral and derivative control terms. The method 400 further comprises a step 408 of adjusting the PID control terms based on the fuzzy output variable.

Although not shown in FIG. 4, step 408 may further comprise determining a degree of membership of the fuzzy input variable associated with a fuzzy set. Where determining the fuzzy output variable is further dependent on the degree of membership. In other words the fuzzy output variable is a fuzzy degree of membership of the fuzzy input variable in a qualifying fuzzy set. The degree of membership quantifies the grade of membership of the fuzzy input variable to the respective fuzzy set. The degree of membership is between 0 and 1 and the fuzzy input variable is mapped to a degree of membership value between 0 and 1. The value 0 means that the fuzzy input variable is not a member of the fuzzy set and the value 1 means that the fuzzy input variable is fully a member of the respective fuzzy set. Values between 0 and 1 are for fuzzy input variables which belong to the fuzzy set only partially. The method 400 may further comprise a neural network such that the PID control terms are determined using a neuro-fuzzy gain scheduling system. The neural network advantageously uses a learning algorithm to determine the parameters of the fuzzy logic gain scheduling system such as the fuzzy set data.

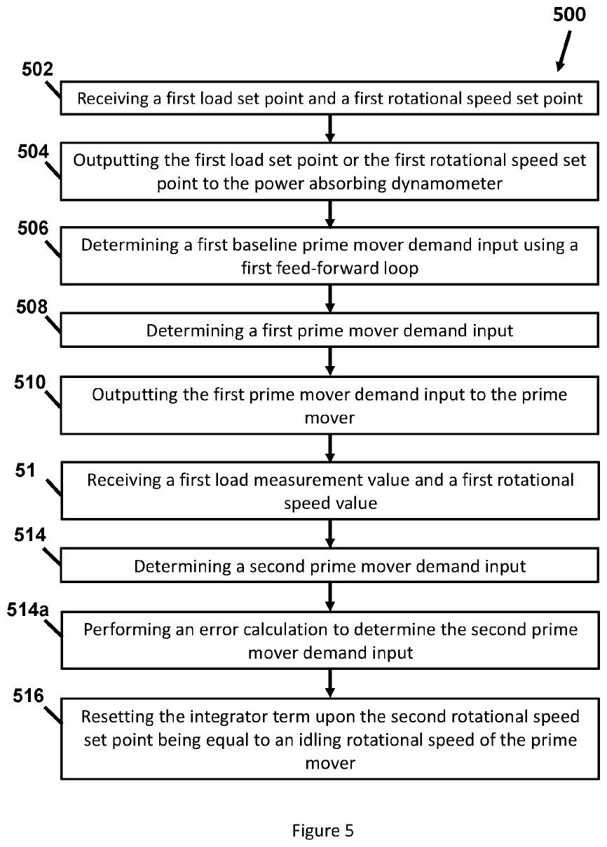

FIG. 5 illustrates a further example method 500 of transient testing a prime mover embodying the present disclosure. Some of the steps of method 500 are identical to method 300, in particular steps 502, 504, 506, 508, 510, 512, 514, 514a which are identical to steps 302, 304, 306, 308, 310, 312, 314 and 314a. The method 500 further comprises a step 516 of resetting the integral term upon the second rotational speed setpoint being equal to an idling rotational speed of the prime mover. Therefore, according to step 516, when the prime mover is idling the integral term is reset and as a result the integral term is nullified. In particular, the integral term is reset upon being greater than an upper threshold value, or upon being less than a lower threshold value. The upper threshold value is between about 7,500 and about 12,500 and the lower threshold value being between about −7,500 and about −12,500. In this example embodiment, the upper threshold value is about 10,000 and the lower threshold value is about −10,000. Step 516 provides a means of preventing instability within the system.

FIG. 6 illustrates a further example method 600 of transient testing a prime mover 102 embodying the present disclosure. Some of the steps of method 600 are identical to method 500, in particular steps 602, 604, 608, 610, 612, 614, 614a and 616 are identical to steps 502, 504, 508, 510, 512, 514, 514a and 516. The method 600 further comprises a step 606 of determining a first baseline prime mover demand input using a first feedforward loop comprising comparing the first load setpoint to a second load setpoint and/or the first rotational speed setpoint to a second rotational speed setpoint. The first feedforward loop of step 606 is configured to provide a baseline prime mover demand input based on the next input. The control system is then configured to alter and adjust this baseline prime mover demand input to provide a second prime mover demand input based on the error calculation performed at step 614a. Step 606 ensures that the prime mover always meet a minimum threshold prime mover demand input. Step 606 may further comprise comparing the difference between the first load setpoint and the second load setpoint to a first feedforward load threshold value and/or comparing the difference between the first rotational speed setpoint and the second rotational speed setpoint to a first feedforward rotational speed threshold value.

Further, upon the first load setpoint being equal to the second load setpoint the method step 606 is configured to set the first baseline prime mover demand input to the first prime mover demand input, and/or upon the first rotational speed setpoint being equal to the second rotational speed point setting the first baseline prime mover demand input to the first prime mover demand input.

Furthermore, upon the first load setpoint being greater than or less than the second load setpoint setting the first baseline prime mover demand input in dependence on the second load setpoint, and/or upon the first rotational speed setpoint being greater than or less than the second rotational speed point setting the first baseline prime mover demand input in dependence on the second rotational speed setpoint.

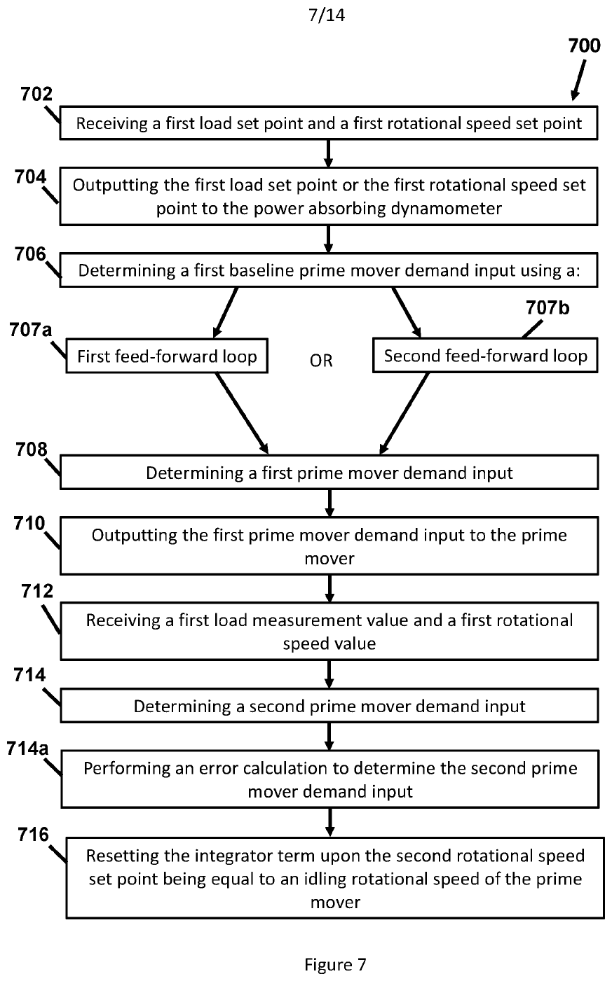

FIG. 7 illustrates a further example method 700 of transient testing a prime mover embodying the present disclosure. Some of the steps of method 700 are identical to method 600, in particular 702, 704, 708, 710, 712, 714, 714a and 716 are identical to steps 602, 604, 608, 610, 612, 614, 614a and 616. The method 700 further comprises steps 706, 707a and 707b. Step 706 and 707a is effectively identical step 606, however the step of determining a first baseline prime mover demand input further comprises a second feedforward loop as represented by step 707b.

Step 707b is triggered upon the first rotational speed setpoint being equal to the idling rotational speed of the prime mover. Upon the first rotational speed setpoint being equal to the idling rotational speed of the prime mover, step 706 of determining a first baseline prime mover demand input further comprises using a second feedforward loop. The first rotational speed setpoint represents the current setpoint at the current time point.

Step 707b comprises comparing a difference between the first load setpoint and an Nth load setpoint to a second feedforward load threshold value and/or comparing a difference between the first rotational speed setpoint and an Nth rotational speed setpoint to a second feedforward rotational speed threshold value. Where the step 707b may further comprises the step of upon exceeding the load threshold, setting the first baseline prime mover demand input in dependence on the first load setpoint and/or upon exceeding the rotational speed threshold, setting the first baseline prime mover demand input in dependence on the first rotational speed setpoint. In this example embodiment, the Nth load setpoint is the third load setpoint, and the Nth rotational speed setpoint is the third rotational speed setpoint.

As illustrated in FIG. 7, the first baseline prime mover demand input is either determined by the first feedforward loop or the second feedforward loop.

There may be a further step of method 700 of determining the first and second feedforward load threshold values and determining the first and second feedforward rotational speed threshold values. In this example embodiment, the first feedforward rotational speed threshold value is about 10 RPM and the first feedforward load threshold value is about 10 Nm. The second feedforward rotational speed threshold value is about 20 Nm and the second feedforward load speed threshold value is about 20 RPM. These threshold values may vary depending on the prime mover under test, for example the threshold values may vary between an electric motor and an internal combustion engine. In particular, the load threshold value and/or the rotational speed threshold value are determined in dependence on the inertia of the prime mover. Further, it has been found that the load threshold value may be at least the reciprocal of a rated load of the prime mover.

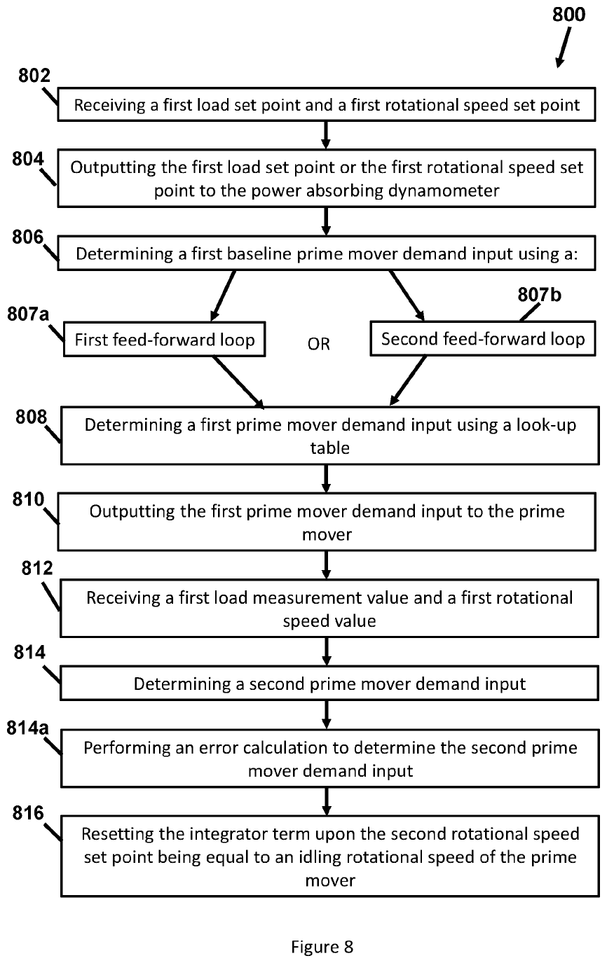

FIG. 8 illustrates a further example method 800 of transient testing a prime mover 102 embodying the present disclosure. Some of the steps of method 800 are identical to method 700, in particular steps 802, 804, 806, 807a, 807b, 810, 812, 814, 814a and 816 are identical to steps 702, 704, 706, 707a, 707b, 710, 712, 714, 714a, and 716. The method 800 further comprises the step 808 of determining a first prime mover demand input using a look-up table, based on the load setpoint and/or the rotational speed setpoint. Step 808 uses a look-up table which translates the load setpoint and/or rotational speed setpoint to a first prime mover demand input, for example, to a pedal position that corresponds to that load setpoint according to the look-up table for that prime mover.

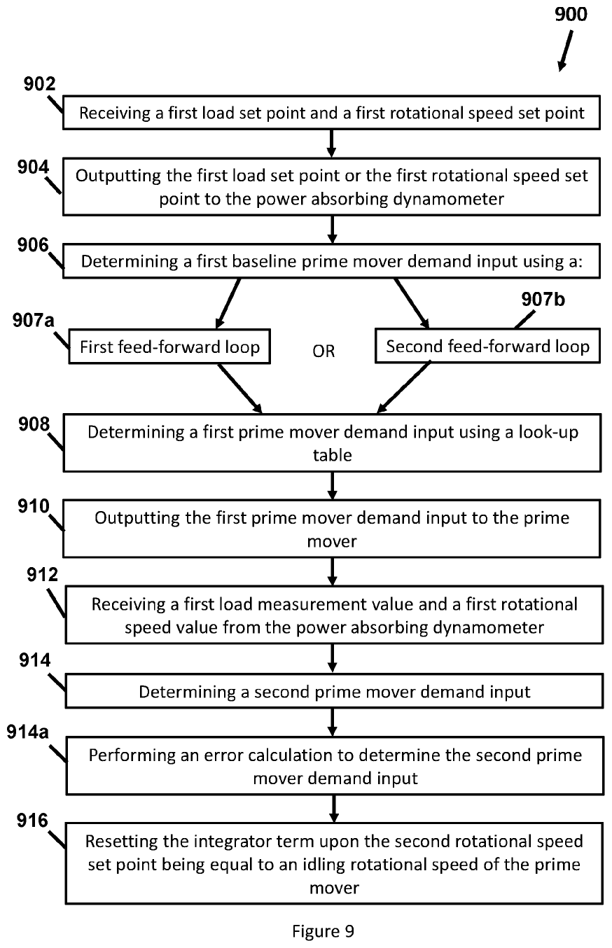

FIG. 9 illustrates a further example method 900 of transient testing a prime mover 102 embodying the present disclosure. Some of the steps of method 900 are identical to method 800, in particular steps 902, 904, 906, 907a, 907b, 908, 910, 914, 914a and 916 are identical to steps 802, 804, 806, 807a, 807b, 808, 810, 814, 814a and 816. The method 900 further comprises the step 912 of receiving a first load measurement value and a first rotational speed value from the power absorbing dynamometer 104. Step 912 may further comprise receiving a first load measurement value from a torque transducer on the power absorbing dynamometer 104 and receiving a first rotational speed measurement value from a speed sensor on the power absorbing dynamometer 104. Although not shown in this example embodiment, the first load measurement value and the first rotational speed measurement value may be received, instead, from the output shaft 105 coupling the prime mover 102 and the power absorbing dynamometer 104. The frequency at which step 912 occurs is substantially equal to frequency of step 908 and/or step 914.

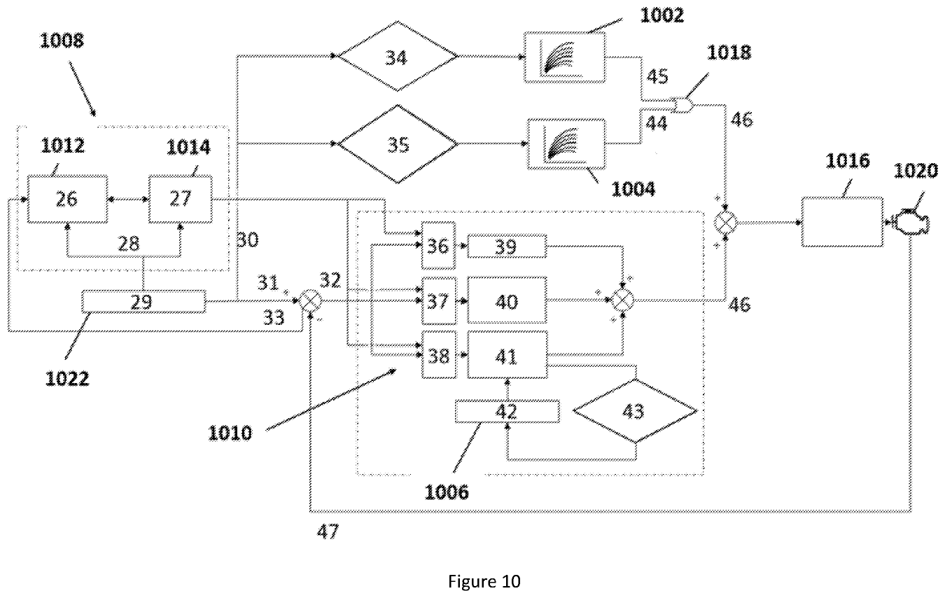

Looking now to FIG. 10 which shows a schematic diagram of the control logic that occurs within the controller. In particular, FIG. 10 illustrates the first feedforward loop 1002, the second feedforward loop 1004, the integral windup nullifier 1006, and the neuro-fuzzy logic gain scheduling system 1008. The following referencing applies throughout FIG. 10:—
26. RNN or ANN or DNN
27. Fuzzy Gain Scheduler

$$28. {N}_{t + n} , {T}_{t + n} , \frac{{dN}_{t + n}}{dt} , \frac{{dT}_{t + n}}{dt}$$

29. Operational Target Profile
30. Nₜ, Tₜ, Nₜ₊ₙ, Tₜ₊ₙ
31. Nₜ, Tₜ
32. e(t)
33. e(t)

$$34. {N}_{t + 1} - {N}_{t} \geq {N}_{Threshold}$$

$$35. {N}_{t + n} - {N}_{t} \geq {N}_{Threshold} ; {T}_{t + n} - {T}_{t} \geq {N}_{Threshold} ; {N}_{t} = {N}_{idling}$$

36. K_{P}
37. K_{D}
38. K_{I}
39. e(t)

$$40. \frac{de ( t )}{dt}$$

$$41. {\int }_{0}^{t} e ( τ ) d τ$$

42. Integral Windup Nullifier

$$43. {I}_{term} \geq {I}_{Threshold} V ; {I}_{term} \leq {I}_{Threshold}$$

$$44. \% t , pedal + n$$

$$45. \% t , pedal + 1$$

46. % pedal
47. N_{measured}, T_{measured}

The first feedforward loop 1002 comprises comparing the difference between Nₜ₊₁, i.e., the second rotational speed setpoint and Nₜ, i.e., the first rotational speed setpoint to the first feedforward rotational speed threshold.

The control logic with regards to the second feedforward loop 1004 comprises determining whether Nₜ=N_{idling}. In other words, confirming that the current setpoint equals the pre-determined idling setpoint. The second feedforward loop 1004 further comprises comparing the difference between Nₜ₊ₙ, i.e., the Nth rotational speed setpoint and Nₜ, i.e., the first rotational speed setpoint to the second feedforward rotational speed threshold. The feedforward system comprises an ‘OR’ gate 1018. This gate 1018 is configured such that first baseline prime mover demand input is outputted from the first feedforward loop 1004 or the second feedforward loop 1006.

It will be appreciated that the same control logic can be applied with regards to the load setpoint.

FIG. 10 illustrates the PID controller 1010 and the integral windup nullifier 1006 of the example embodiment. The integral windup nullifier 1006 is configured to reset the integral term upon the integral term being greater than an upper integral threshold value, i.e., Iₜₑᵣₘ≥I_{threshold} or upon the integral term being less than a lower integral threshold value, i.e., Iₜₑᵣₘ≤I_{threshold}.

The gain coefficients K_{P}, K_{P}, and K_{I} of the PID control terms are corrected and/or adjusted by the neuro-fuzzy gain scheduler 1008. As shown in FIG. 10, the neuro-fuzzy gain scheduler 1008, comprises a neural network 1012 and a fuzzy logic gain scheduler 1014. The neural network 1012 may be, for example, an Artificial Neural Network (ANN), Recurrent Neural Network (RNN) or Deep Neural Network (DNN). The neuro-fuzzy gain scheduler 1008 is in communication with an operational target profile 1022, which in turn is in communication with the PID controller 1010.

FIG. 10 further illustrates a prime mover pedal emulator 1016 configured to emulate the prime mover demand input into a readable sign for the prime mover 1020.

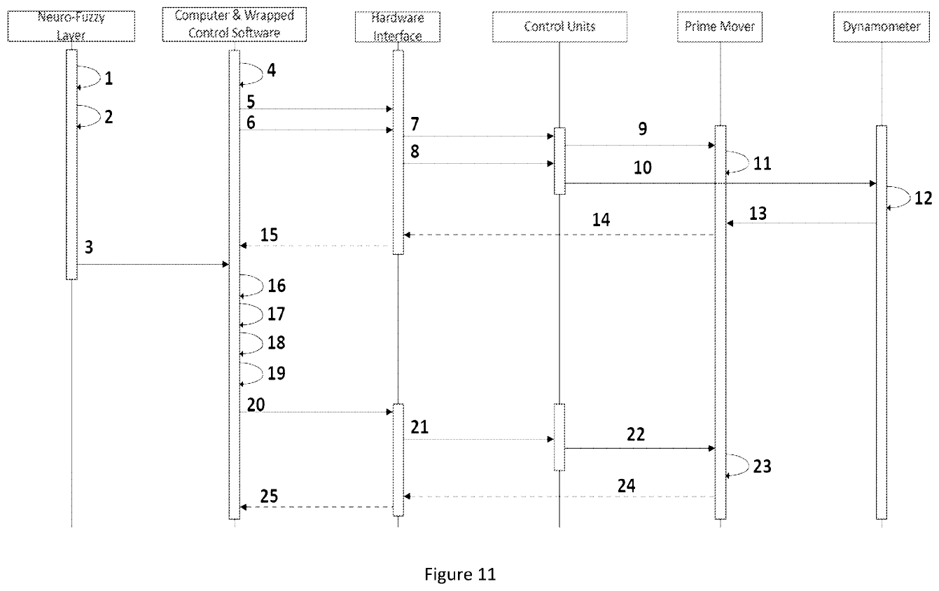

FIG. 11 shows a sequence diagram that provides a detailed overview of the operation of the control system. In particular, FIG. 11 demonstrates a sequence diagram for a prime mover under rotational speed control and provides further context of when each step takes place in relation to other steps and the time points in the testing method. The following referencing applies throughout FIG. 11:—
1. Determine the fuzzy set applicable for the upcoming set of transient brake torque and engine speed events;
2. Assign integrator windup solution OR assign variants of PID coefficients;
3. Assign Neuro-Fuzzy Correction to PID controller
4. Read time-step and baseline T_{b} and Nᵣₚₘ from defined profile and send corresponding feed-forward signal from calibrated map;
5. Send corresponding baseline pedal set-point;
6. Send brake torque set-point;
7. Send corresponding signal for desired pedal set-point;
8. Send corresponding signal for desired torque set-point;
9. Relay pedal position signal to electromechanical device;
10. Relay torque set-point to electromechanical device;
11. Produce revs, Nᵣₚₘ, reflecting baseline pedal position;
12. Convert signal into a resistive electromagnetic force corresponding to torque set-point;
13. Opposing torque by dynamometer deviates engine speed from set-point;
14. Update engine speed reading;
15. Send updated engine speed reading;
16. PID calculates deviation in rpm;
17. Feedforward II pedal allocation check and set-point;
18. PID control system calculates corrective throttle position;
19. System verifies integrator windup state;
20. Send corrective pedal set-point from PID;
21. Send corresponding signal for desired pedal set-point;
22. Relay pedal position signal to electromechanical device;
23. Produce revs, Nᵣₚₘ, reflecting corrective pedal position; and
24. Update engine speed reading.

The computer and wrapped control software is the controller, in particular the PID controller, of the present disclosure. As shown in FIG. 11, the controller is configured to output the first baseline prime mover demand input and the first load setpoint, represented as brake torque setpoint in FIG. 11. The hardware interface is an interface integrated into the control system such as the emulation system described with respect to FIG. 1. The hardware interface is configured to emulate the first load setpoint and the prime mover demand input received from the controller into corresponding readable signals for the either the prime mover or the power absorbing dynamometer. The first baseline prime mover demand input is emulated into a corresponding signal for desired pedal setpoint which is the equivalent to the first prime mover demand input of the present disclosure. The first load setpoint is emulated into a corresponding signal for the first load setpoint to be received and read by the absorbing dynamometer.

As shown in FIG. 11, the prime mover and the power absorbing dynamometer may have respective control units configured to read the signals outputted from the controller and/or the emulation device and relay these signals to their respective device, i.e., either the prime mover or the power absorbing dynamometer.

The process at the power absorbing dynamometer involves converting the signal, i.e., the first load setpoint in this example embodiment, into a resistive electromagnetic force corresponding to the first load setpoint.

The prime mover receives the first prime mover demand input from the prime mover control unit and produces a rotational speed reflecting said first prime mover demand input. However, as shown in FIG. 11, the opposing load from the absorbing dynamometer, which is coupled to the prime mover, deviates the prime movers rotational speed from the rotational speed setpoint. The opposing load from the absorbing dynamometer is the equivalent to the first load setpoint.

In this example embodiment, the prime mover is configured to relay back to the controller the updated prime mover rotational speed reading, i.e., the first rotational speed measurement value. The controller uses this first rotational speed measurement value to calculate the deviation in rotational speed and determine a second prime mover demand input. This adjusted and/or corrected second prime mover demand input is then outputted from the PID controller to the prime mover through the steps highlighted above. The steps described above and shown in FIG. 11 occur during the first time point and the second time point.

Meanwhile, the neuro-fuzzy logic layer, which represents the neuro-fuzzy logic gain scheduling system of the present disclosure, is working to adjust and/or correct the PID control terms used to calculate the prime mover demand input. The neural network of the neuro-fuzzy layer is looking at the upcoming set of transient events and determines and/or predicts the fuzzy sets applicable for these events. This learning algorithm provided by the neural network allows more precise PID control terms and as a result more precise control of the prime mover.

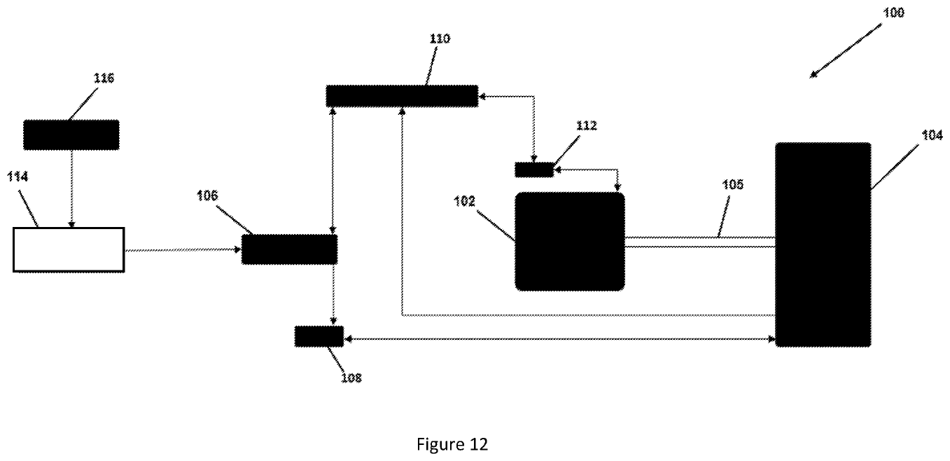

FIG. 12 illustrates the control system of FIG. 1 further comprising a prime mover model converting prime mover speed profile 116 into a load and rotational speed trace.

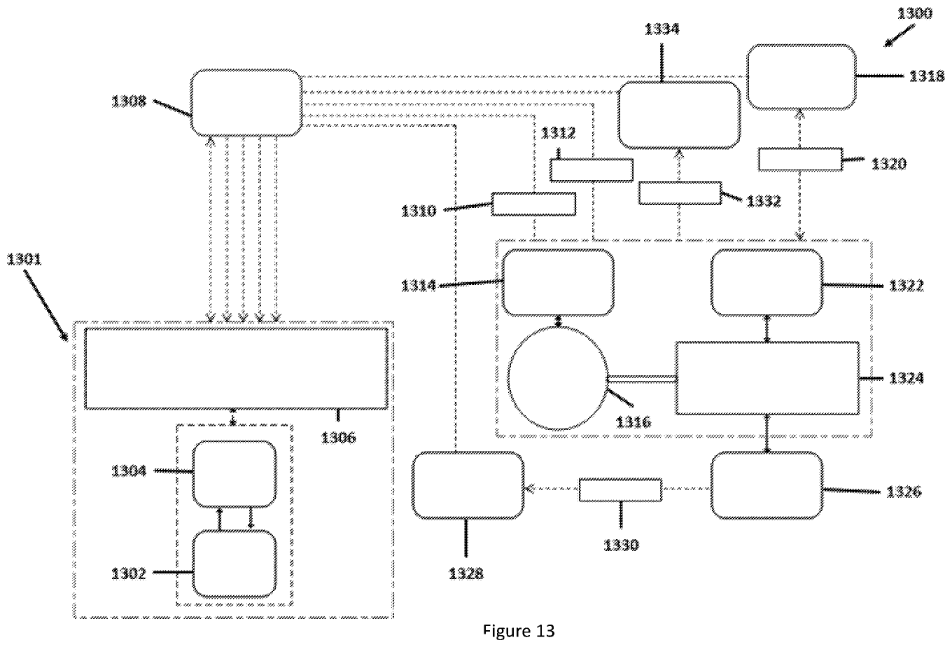

FIG. 13 illustrates a data interaction map 1300 for an example embodiment of a method of transient testing a prime mover. The data interaction map 1300 comprises a control system 1301, where the control system 1301 comprises feedforward database 1302 configured to feedforward to a PID control system 1304. The feedforward database 1302 comprises at least a first feedforward loop and a second feedforward loop, The control system 1301 further comprises a prime mover software interface/application 1306. The prime mover software interface/application 1306 may be, for example, Python, C++ application, NI LabView application or MATLAB Simulink application.

FIG. 13 further comprises a computer 1308, said computer 1308 may be a desktop or a PC, for example. The computer 1308 is in communication with the control system 1301 and outputs a load setpoint 1310 and/or a rotational speed setpoint 1312 to a power absorbing dynamometer control unit 1314, which in turn outputs the signal to a power absorbing dynamometer 1316.

The computer 1308 also outputs the prime mover demand input 1320, for example, a throttle position, via an emulator 1318 to a prime mover control unit 1322. The prime mover control unit 1322 then outputs the signal to the prime mover 1324 which is coupled to the power absorbing dynamometer 1316. The prime mover 1324 may be an internal combustion engine, an electric motor, or a hybrid powertrain comprising an internal combustion engine and an electric motor.

The prime mover 1324 comprise at least one instrumented gauging device 1326 configured to output a temperature reading 1330 to a data logger 1328. Further a mass flowrate/power reading 1332 is outputted to a fuel flowmeter and/or a power gauge 1334 from either the prime mover 1324 or the power absorbing dynamometer 1316. The fuel flowmeter and/or a power gauge 1334 outputs this data back to the computer 1308 and the control system 1301.

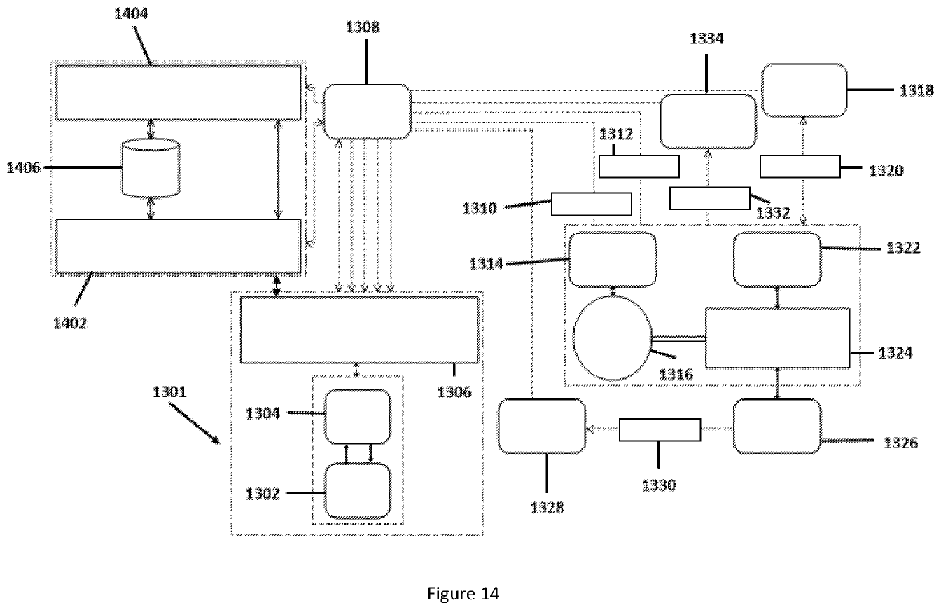

FIG. 14 illustrates the data interaction map of FIG. 13 further comprising machine learning. The data interaction map of FIG. 14 comprises a machine learning module 1402. The machine learning module 1402 may comprise C++ application and/or Python, R, or TensorFlow API. The machine learning module 1402 is in communication with the control system 1301 and the computer 1308. Further, a prime mover simulation software application 1404 is incorporated, where the machine learning module 1402 and the prime mover simulation software application 1404 are configured to receive and output data to a common database 1406. The prime mover simulation software application 1404 is in communication with the computer 1308 and the machine learning module 1402.

The prime mover of any of FIGS. 1 to 14 described above may be an electric motor or a combustion engine. Other suitable prime movers will be appreciated by the skilled person.

1. A method of transient testing a prime mover wherein the prime mover is coupled to a power absorbing dynamometer, the method comprising the steps of:
receiving a first load setpoint and a first rotational speed setpoint, wherein the first load setpoint and the first rotational speed setpoint correspond to a first time point in a prime mover testing profile, wherein the prime mover testing profile is a model of a real-world testing profile;
outputting the first load setpoint or the first rotational speed setpoint to the power absorbing dynamometer;
determining a first baseline prime mover demand input using a first feedforward loop;
determining a first prime mover demand input, wherein the first prime mover demand input is based on the first baseline prime mover demand input and the first load setpoint or the first rotational speed setpoint;
outputting the first prime mover demand input to the prime mover;
wherein, upon the first load setpoint being provided to the power absorbing dynamometer, the first prime mover demand input is based on the first baseline prime mover demand input and the first rotational speed setpoint, and wherein, upon the first rotational speed setpoint being provided to the power absorbing dynamometer, the first prime mover demand input is based on the first baseline prime mover demand input and the first load setpoint;
receiving a first load measurement value and a first rotational speed measurement value; and
determining a second prime mover demand input based on: the first prime mover demand input or a second baseline prime mover demand input; a second load setpoint or a second rotational speed setpoint; and the first load measurement value or the first rotational speed measurement value.

2. The method of transient testing a prime mover according to claim 1, wherein the step of determining the second prime mover demand input further comprises performing an error calculation between one of:
the first load measurement value and the second load setpoint; and
the first rotational speed measurement value and the second rotational speed setpoint.

3. The method of transient testing a prime mover according to claim 2, wherein the error calculation comprises determining PID control terms.

4. (canceled)

5. The method of transient testing a prime mover according to claim 3, wherein the PID control terms are determined using a fuzzy logic scheduling system, the fuzzy logic gain scheduling system configured to:
determine a fuzzy input variable, wherein the fuzzy input variable is based on, an error value and a change in error value, wherein the error value is the difference between one of: the first load measurement value and the first load setpoint; and first rotational speed measurement value and the first rotational speed setpoint;
receive fuzzy set data;
determine a fuzzy output variable based on the fuzzy input variable and the fuzzy set data; and
adjust the PID control terms based on the fuzzy output variable.

6. The method of transient testing a prime mover according to claim 5, further comprises determining a degree of membership of the fuzzy input variable associated with a fuzzy set, wherein determining the fuzzy output variable is further dependent on the degree of membership.

7. The method of transient testing a prime mover according to claim 5, wherein the fuzzy input variable is further based on the rate of change between the first load measurement value and the second load measurement value and/or between the first rotational speed measurement value and the second rotational speed measurement value.

8. (canceled)

9. The method of transient testing a prime mover according to claim 3, wherein the integral term is reset upon the second rotational speed setpoint being equal to an idling rotational speed of the prime mover.

10. (canceled)

11. (canceled)

12. The method of transient testing a prime mover according to claim 1, wherein the step of determining a first baseline prime mover demand input using a first feedforward loop comprises comparing the first load setpoint to a second load setpoint and/or the first rotational speed setpoint to a second rotational speed setpoint.

13. The method of transient testing a prime mover according to claim 12, wherein the step of determining a first baseline prime mover demand input using a first feedforward loop further comprises comparing the difference between the first load setpoint and the second load setpoint to a first feedforward load threshold value and/or comparing the difference between the first rotational speed setpoint and the second rotational speed setpoint to a first feedforward rotational speed threshold value.

14. (canceled)

15. (canceled)

16. The method of transient testing a prime mover according to claim 1, wherein, upon the first rotational speed setpoint being equal to the idling rotational speed of the prime mover, the step of determining a first baseline prime mover demand input further comprises using a second feedforward loop.

17. The method of transient testing a prime mover according to claim 1, wherein the step of determining a first baseline prime mover demand input further comprises using a second feedforward loop triggered during rotational speed setpoint not being equal to the idling rotational speed of the prime mover.

18. The method of transient testing a prime mover according to claim 16, wherein said second feedforward loop comprises comparing a difference between the first load setpoint and an Nth load setpoint to a second feedforward load threshold value and/or comparing a difference between the first rotational speed setpoint and an Nth rotational speed setpoint to a second feedforward rotational speed threshold value.

19. The method of transient testing a prime mover according to claim 18, wherein upon exceeding the second feedforward load threshold, setting the first baseline prime mover demand input in dependence on the Nth load setpoint and/or upon exceeding the second feedforward rotational speed threshold, setting the first baseline prime mover demand input in dependence on the Nth rotational speed setpoint.

20. The method of transient testing a prime mover according to claim 18, wherein the first feedforward load threshold value is the same or less than the second feedforward load threshold value and wherein the first feedforward rotational speed threshold value is the same or less than the second feedforward rotational speed threshold value.

21. The method of transient testing a prime mover according to claim 18, wherein the Nth load setpoint is the third load setpoint and/or wherein the Nth rotational speed setpoint is the third rotational speed setpoint.

22. The method of transient testing a prime mover according to claim 1, wherein the step of determining the first prime mover demand input and/or the second prime mover demand input is carried out at a frequency dependent on the maximum rotational speed of the prime mover.

23. (canceled)

24. (canceled)

25. The method of transient testing a prime mover according to claim 1, wherein the time between a first time point and a second time point in the prime mover testing profile is between about 0.1 seconds and about 2 seconds, preferably 1 second.

26. The method of transient testing a prime mover according to claim 25, wherein for each step of determining the prime mover demand input between a first time point and a second time point of the prime mover testing profile, the load setpoint and the rotational setpoint remain constant.

27. (canceled)

28. (canceled)

29. (canceled)

30. The method of transient testing a prime mover according to claim 1, wherein the frequency at which the load measurement value and the rotational speed measurement value are received is substantially equal to the frequency of carrying out the step of determining the first prime mover demand input and/or the second prime mover demand input.

31. (canceled)

32. (canceled)

33. (canceled)
